(19) United States
(12) Patent Application Publication
(10) Pub. No.: US 2012/0036308 A1
(43) Pub. Date: Feb. 9, 2012

(54) SUPPORTING A SECURE READABLE MEMORY REGION FOR PRE-BOOT AND SECURE MODE OPERATIONS

(76) Inventors: Robert C. SWANSON, Olympia, WA (US); Vincent J. ZIMMER, Federal Way, WA (US); Eric R. WEHAGE, Tenino, WA (US); Mallik BULUSU, Olympia, WA (US)

(21) Appl. No.: 12/852,280

(22) Filed: Aug. 6, 2010

(51) Int. Cl. G06F 12/14; G06F 12/02; G06F 12/00

(52) U.S. Cl. 711/1; 711/170; 711/100; 711/118; 711/E12.002; 711/E12.091

(57) ABSTRACT

In one embodiment, the present invention includes a method for determining whether an address map of a system includes support for a read only region of system memory, and if so configuring the region and storing protected data in the region. This data, at least some of which can be readable in both trusted and untrusted modes, can be accessed from the read only region during execution of untrusted code. Other embodiments are described and claimed.

### BACKGROUND

As computer platforms become more complex, software including basic input/output system (BIOS) and BIOS-to-operating system (OS) communication routines are being targeted for attacks. These attacks can target Advanced Configuration and Power Interface (ACPI) and Unified Extensible Firmware Interface (UEFI) runtime services. In addition to these attacks, BIOS system management mode (SMM) areas are continually growing, but the feature and subsequent memory footprint required for BIOS continually grows. In many cases this footprint is growing at a rate faster than the top segment of memory (TSEG), a reserved memory region that is visible and accessible only in SMM.

Currently the only method of protecting memory against attack is by keeping shared memory in SMM, and the OS executes a system management interrupt (SMI) to enable entry into the SMM. The BIOS will see the SMI source and perform some action on its internally protected memory, which is called system management random access memory (SMRAM) or TSEG. This has several architectural issues. First, execution of an SMI has an overhead. On the current generation of platforms, OS vendors set a 190 microsecond (μs) total time budget for handling a single SMI. Many BIOS implementations are not able to meet this requirement. Thus pushing more features and protecting memory in SMRAM is not possible. Second, not all information stored in SMRAM needs to be protected from being read. Some critical sections need protection from read and write (RW), but much of the information may only need to be protected from writes or cache attacks. Thus, TSEG as defined today is improperly organized and not scalable in an architecturally efficient manner. Another protection method is to have read-only, write-protected system board flash memory; however, this resource is limited in size and can be updated only across a reset or via SMM-based agent protection.

### BRIEF DESCRIPTION OF THE DRAWINGS

FIG. 1 is a system address map in accordance with one embodiment of the present invention.

FIG. 2 is a block diagram of a system in accordance with an embodiment of the present invention.

FIG. 3 is a flow diagram of a method in accordance with an embodiment of the present invention.

FIG. 4 is a flow diagram of a method in accordance with another embodiment of the present invention.

FIG. 5 is a block diagram of a system in accordance with an embodiment of the present invention.

FIG. 6 is a block diagram of a system in accordance with another embodiment of the present invention.

### DETAILED DESCRIPTION

Embodiments enable system software, and more particularly BIOS, to carve a portion of host visible memory and mark it as read only (RO). This memory region can then be protected from being written or cached unless by an architecturally measured agent, e.g., BIOS executing in a secure context. While the scope of the present invention is not limited in this regard, logic of a processor, memory controller, and/or chipset may be used to provide the memory protection. The protected memory can be executed from and read by the OS without concern that it has been modified. Embodiments can protect various information such as critical BIOS components of the OS communication pathways without impact to platform performance by avoiding SMM overhead or read-only memory (ROM) based execution from a RO flash device. Certain embodiments are described for BIOS-to-OS communication, but without loss of generality other implementations can be applied to virtual machine monitor (VMM)-to-virtual machine (VM) or OS-to-driver communication. Also, this capability could be applied to protect other memory-mapped resources where integrity is a concern but not confidentiality (i.e., any code can read, but only a trusted agent can modify). Note that while particular embodiments herein are described in the context of BIOS, more generally implementations can exist in system firmware beyond BIOS.

Embodiments thus provide a portion of system memory as read-only memory. In the past legacy systems, so-called PC/AT systems, having a “ROM” located at 0xC0000p-0xFFFFF of an address map had emulated chipset support by allowing for these memory locations to be backed by system memory, e.g., dynamic random access memory (DRAM) and using the Memory-Attribute Registers (MAR) or the Programmable Attribute Map (PAM) registers in a chipset or uncore to protect these regions. This hardware helped with the “runtime BIOS” for PC/AT legacy.

With the advent of SMBIOS, ACPI, and Unified EFI (UEFI) runtimes, there may be swaths of memory content that come from the platform and could enjoy the protection of hardware resources in the chipset/platform. For these more modern firmware data tables and code, a secure execution mode such as original equipment manufacturer (OEM) SMM can be used to be the reference monitor/guard of these resources. Embodiments thus may be used to provide a robust and secure platform experience.

Also, for systems without SMM or that have SMM security considerations, this capability may be available at platform reset when the manufacturer system board firmware initially runs, is configured and locked prior to running any third party content (e.g., option ROM, OS loader, OS runtime). This is applicable because the provenance of the UEFI runtime, SMBIOS, ACPI should be the system board manufacturer and provisioned in the factory prior to shipping the system.

Another embodiment of the SMM software logic could be an integrated service processor in the CPU package. For example, a system on a chip can have a cryptographic co-processor integrated along with the main CPU core. Such ancillary processing units are typically called portions of an ‘uncore’ to distinguish them from the main computational core(s). This co-processor could effect the same flows as the BIOS-based SMM.

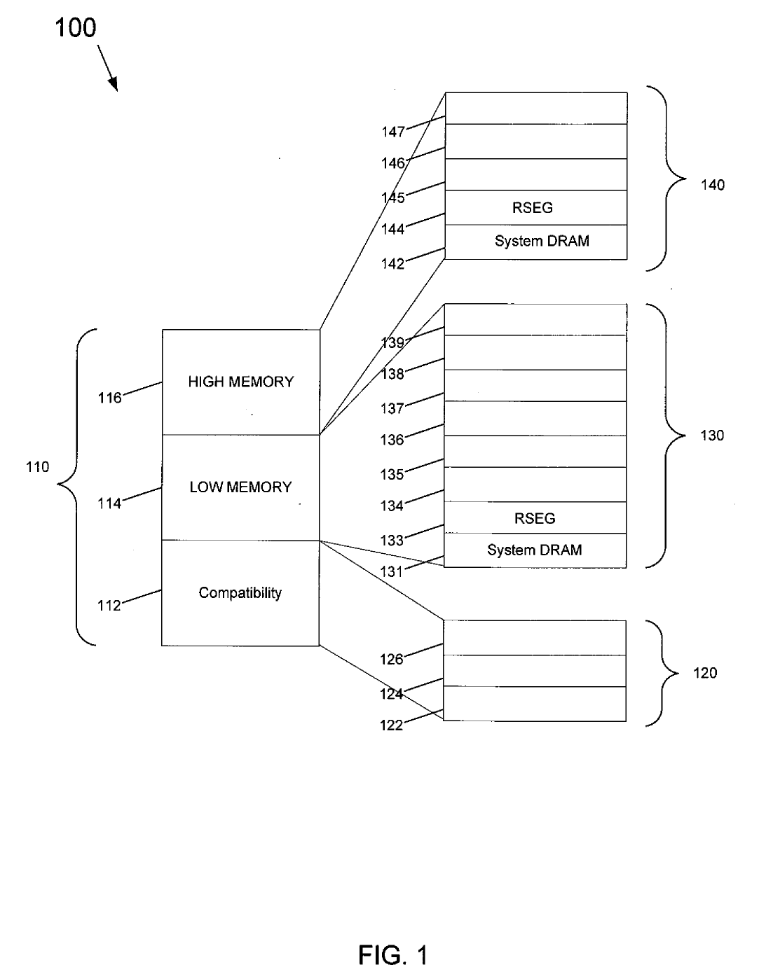

Referring now to FIG. 1, shown is a system address map including a read only segment region (RSEG) in accordance with one embodiment of the present invention. In different embodiments, the RSEG could be multiple regions of high and low memory.

As shown in FIG. 1, a system address map 100 is provided. In general, map 100 provides an address space of all available memory within a system. In various embodiments, the system address map may be present in a chipset, memory controller, processor (e.g., uncore logic) or other location. In general, the memory map may include an address space 110 which provides a software view of memory. As seen in the embodiment of FIG. 1, the address space can be segmented into a compatibility region 112, a low memory region 114, and a high memory region 116. In the example of FIG. 1, compatibility region 112 may be 1 megabyte (MB), low memory region 114 extending to 4 gigabytes (GB), and high memory region 116 extending to 16 terabytes (TB), although the scope of the present invention is not limited in this regard.

This address space maps to actual physical memory within the system, which may be present in various locations including DRAM and memory present on devices, memory mapped input/output (MMIO) and so forth. As seen, compatibility region 120 may include a disk operating system (DOS) range 122, a video graphics adapter (VGA) memory 124, and a PAM region 126. In turn, low memory region 114 may map to a portion of system memory, e.g., DRAM low memory 131. Next, an RSEG region 133 in accordance with an embodiment of the present invention may be provided. In different implementations, the amount of this region may be configurable to be between approximately 1 MB (for a space constrained system like a deeply integrated system-on-a-chip) to 128 MB (for a large enterprise server). Above this region, a MMIO low region 134 may be present. Then a TSEG region 135 which may correspond to SMRAM may be present. Then various memory apertures, which may provide pointers to other memory locations may be present. Such memory apertures may include an JO advanced programmable interrupt controller (APIC) aperture 136, a trusted platform module (TPM) aperture 137, a local APIC aperture 138, and a BIOS aperture 139, which may point to a flash memory including the BIOS image.

In turn, high memory region 116 may map to memory region 140, which includes a system DRAM high memory region 142, a high RSEG region 144, along with various memory apertures such as an MMIO high region aperture 145, a reserved aperture 147, and a privileged control and status register (CSR) aperture 147. While shown with this particular implementation for example in the embodiment of FIG. 1, understand the scope of the present invention is not limited in this regard.

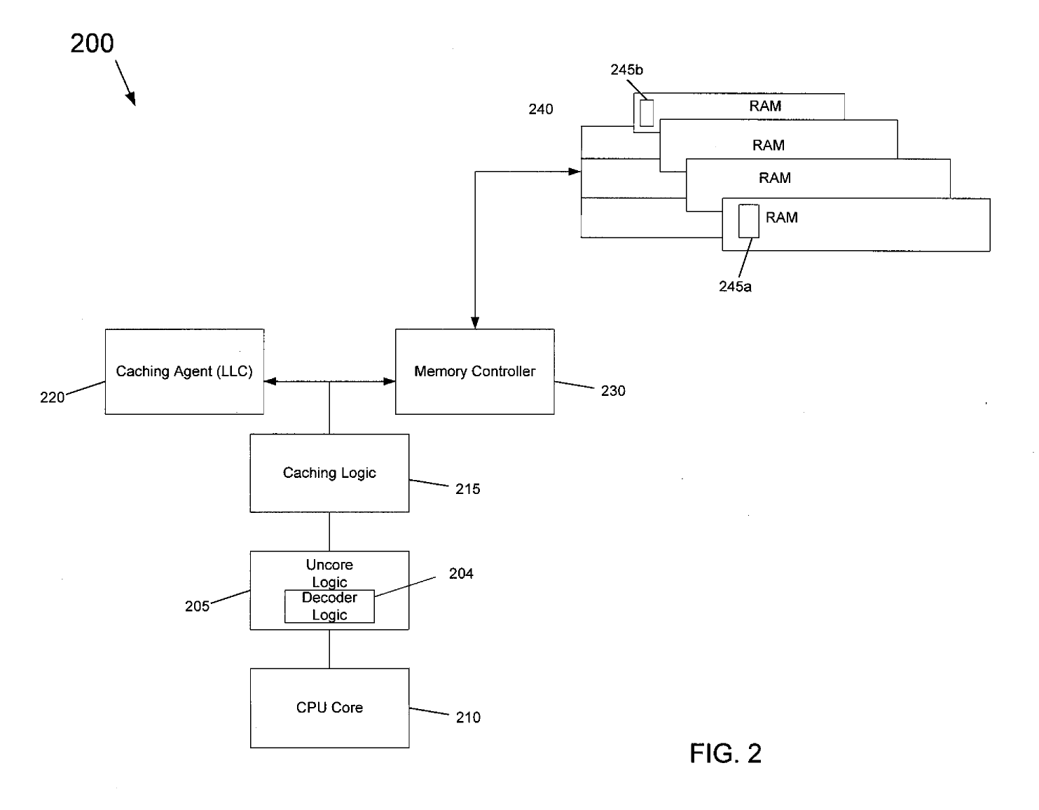

FIG. 2 is a logical view of an implementation of protection for a RSEG in accordance with one embodiment of the present invention. Referring now to FIG. 2, a system 200 may include a central processing unit (CPU) core 210 which may couple through an uncore logic 205 and a caching logic 215 to a caching agent 220, which in one embodiment may be a last level cache (LLC), and a memory controller 230. Note that in various implementations, all of these components may be integrated within a single semiconductor die, e.g., a multicore processor including an integrated memory controller. However, the scope of the present invention is not limited in this regard. As seen further, memory controller 230 couples to a system memory 240, which in the embodiment shown may be a dynamic random access memory which may be implemented via a plurality of dual inline memory modules (DIMMs). As seen, at least certain of the DRAMs may include RSEG regions 245ₐ and 245_{b}.

As to core 210, it can execute the RSEG region but cannot write the range unless it is executing a trusted agent. This can be accomplished by assigning the RSEG region to be read/writeable, under certain conditions. For example, BIOS SMM handlers may be used to change the RSEG region but no other entity can do so. With regard to system memory 240, the RSEG regions 245 can thus be configured by BIOS as a range carved out of a node's portion of the system address map. As seen, the region can be spread across any combination of physical or virtual RAM devices.

With respect to caching agent 220, it may operate to prevent caching of the range of the RSEG regions for non-SMM write accesses. In this way, cache attacks may be avoided. Still further, in other embodiments in addition to preventing caching of the RSEG region for non-SMM write operations, similar cache prevention may occur for non-SMM reads.

In one embodiment, the following registers can be provided. While the location of the registers can vary (and there may be multiple instantiations in some embodiments), as one example the registers may be present as part of an address decoder logic 204 of uncore logic 205 of a processor. For purposes of discussion, assume the registers can also be present in each caching agent. Of course the registers may be located in other places such as the caching logic, chipset logic and so forth. These registers define the region of RSEG in DRAM, e.g., both in lower and upper memory. Specifically, these registers include control registers to define the bounds of the protected region:

RSEGHI_BASE beginning of RSEG region in the upper 4G region [63:20] (e.g., 1 MB increments; most significant bit (MSB) can be lower than 63)

RSEGHI_LIMIT end of RSEG region in upper region

RSEGLO_BASE beginning at RSEG region in the lower 4G region [32:20] (1 MB increments)

RSEGLO_LIMIT end of RSEG region in lower region

RSEG_CTRLSTS contains an enable bit and a status bit.

In various implementations, this control register or other such registers may further include a RSEG_LOCK_PERM lock bit that is set prior to running third party code, so that RSEG protection settings cannot be changed, such as n-tuple of registers of above, by any agent later, including SMM. Note that this bit may be ignorable if a RSEG_LOCK_ONLY_SMM_ACCESSIBLE lock bit is already set. This RSEG_LOCK_ONLY_SMM_ACCESSIBLE lock bit can be set prior to running third party code, so that RSEG protection settings cannot be changed, such as n-tuple of registers of above, by any agent later other than SMM. Again, this bit may be ignorable if RSEG_LOCK_PERM is already set. These registers should be available to early system board firmware code prior to locking, and then only to SMM code after locking.

One example of information to be protected in the RSEG may be UEFI runtime services. First during power on self test (POST), BIOS will initialize memory as normal. The BIOS embodiment can include but is not limited to the security initialization (SEC), pre-EFI (PEI), and driver execution environment (DXE) phases of execution, as defined in the Platform Initialization Specifications, Volumes 1-5, available at www.uefi.org. Next, BIOS configures RSEG to be the region of memory which occupies the UEFI runtime services and loads the service into this region. Thereafter, the BIOS will lock this memory range, e.g., by setting up the boundary and control registers. This has the effect of enforcing caching agents to block/stop caching of the RSEG region. Note that BIOS SMM can execute later to change the size of the RSEG region, e.g., by updating of the boundary registers. All BIOS running up to this point has been provisioned by the platform manufacturer and is thus trusted. After setting up the region and sets the appropriate locks, BIOS boots the operating system and runs other third party code, such as UEFI or conventional PC/AT BIOS option ROM's from host-bus adapters (HBA). Then, subsequent usages of UEFI runtime services can be trusted by all platform entities because it is now RO, and immutable.

During normal system operation when an RSEG violation occurs the request is trapped (e.g., by the caching logic) and RSEG_LOCK_ONLY_SMM_ACCESSIBLE is set, the status bit is set in the RSEG control register, and an SMI is generated. When SMM code is executed, it clears the status bit and a completion for the trapped request is returned to the core, which may be in the form of a master abort such as a CRAB_ABORT (e.g., false data is generated and sent back to the requester). For systems with RSEG_LOCK_PERM set, attempts to write to a region covered by RSEG will be ignored.

If the caching logic receives either a non-SMM write or non-SMM request for ownership (which is a request to a cache to seek data in an Exclusive (E) state), it will trap the request and signal a message to generate an SMI. The request will be held until the SMM code clears the RSEG status indicator in the RSEG control register, and then the SMM is exited, allowing the caching logic to generate a CRAB_ABORT to the core. In various embodiments, caching logic will allow non-caching reads and read requests that cache in a shared (S)-state (S-state prevents writes to the cache). Thus by allowing the region to be cached only in S-state allows the code to run at full speed, but still prevents writes.

Note that SMM code may be allowed to cache the RSEG region in E-state or modified (M)-state, but thereafter the cache is flushed before returning to normal execution. Also note that the above-described registers have no effect if LIMIT=<BASE or if the enable bit in RSEG_CTRLSTS is not set. To provide full protection, SMM code may be allowed to alter the contents of these registers (using previously defined mechanisms). To enhance performance, any request originating from an input/output (IO) device will be sent to the caching logic, where it can be immediately CRAB_ABORT'd (since this came from IO, there is no need to stall a core by trapping it or signaling SMI).

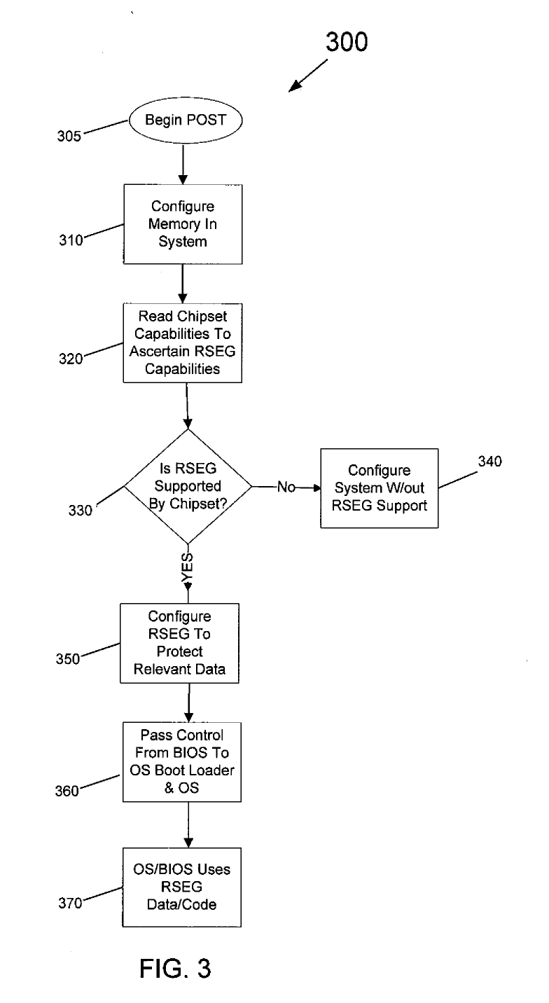

Referring now to FIG. 3, shown is a flow diagram of a method in accordance with an embodiment of the present invention. More specifically, FIG. 3 shows an implementation for using BIOS to set up an RSEG region in accordance with an embodiment of the present invention. As shown, method 300 may begin at a power on self test (POST) operation of the system, which may occur via BIOS (block 305). After successful POST, the BIOS may configure memory of the system (block 310). Then, control passes to block 320, where the BIOS may read chipset capabilities to ascertain whether the system is configured for RSEG capabilities. That is, a chipset may be configured to provide for an address space including one or more RSEG regions (such as shown in FIG. 1), as indicated by registers, e.g., present in a configuration space that indicate this special configuration. Accordingly, BIOS may assign and load a device driver to enable RSEG operations in accordance with an embodiment of the present invention.

Still referring to FIG. 3, if at diamond 330 it is determined that RSEG is not supported by the chipset, control passes to block 340, where further system configuration may be performed by BIOS without RSEG support. Otherwise, control passes to block 350, where BIOS may configure one or more RSEG regions to protect relevant data. While the scope of the present invention is not limited in this regard, such protected data may include UEFI runtime data, UEFI runtime code, ACPI data such as ACPI tables, SMBIOS tables, volume licensing information (such as OS activation keys), platform identifiers and certifications (such as the platform manufacturer credential for a system board that supports a trusted platform module, as described at www.trustedcomputinggroup.org, and so forth. After such configuration, which may include setting up of various registers such as discussed above including base and limit registers as well as control registers, BIOS may pass control to an OS boot loader and in turn to the OS (block 360). Then during normal operations, both BIOS and the OS may access RSEG regions (at least in a read manner) to use the data/code stored therein (block 370). Note that during system operation, BIOS may reconfigure the RSEG regions based upon desired operating characteristics. To implement such reconfiguration, which may include migration of RSEG regions, expansion, resizing, overriding, and so forth, BIOS may set a lock while in an SMM mode to enable update to the RSEG regions, as discussed above with regard to the control register lock bits. While shown with this particular implementation in the embodiment of FIG. 3, understand the scope of the present invention is not limited in this regard.

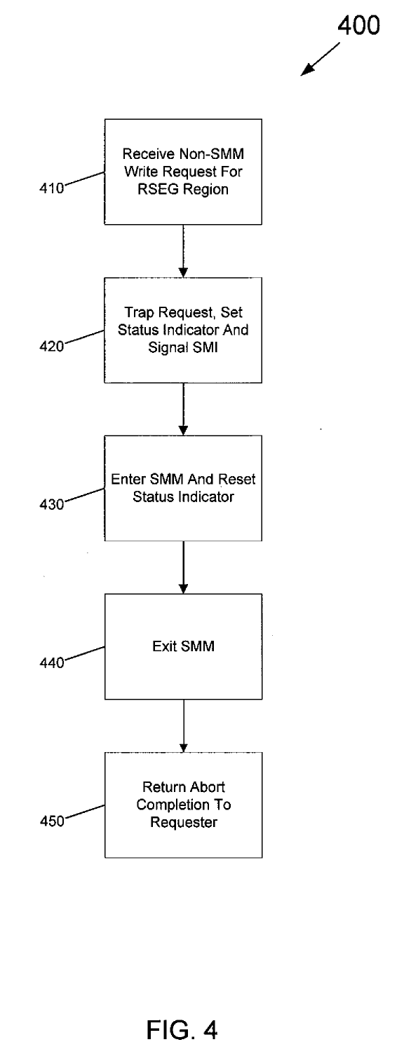

Referring now to FIG. 4, shown is a flow diagram of a method in accordance with another embodiment of the present invention. As shown in FIG. 4, method 400 may be used to handle protection of an RSEG region during system operation. As seen, method 400, which may be implemented using various hardware including, e.g., cache logic, chipset logic, and so forth, may begin when a non-SMM write request is received for an RSEG region (block 410). For purposes of discussion assume that this request is received in logic associated with a cache, e.g., a last level cache. Accordingly, the logic may trap, the request and set a status indicator and signal an SMI (block 420). For example, the status indicator may be of the RSEG control register to indicate that a non-SMM entity has sought write access to the RSEG region. Note that as used herein, the term “non-SMM” is intended to refer to all code outside of a system management mode, including OS and other third party code but not including BIOS code.

Still referring to FIG. 4, SMM mode may be entered responsive to the SMI signal (block 430). For example, a given SMM event handler may be executed. During execution of this handler, the handler may read the RSEG control register(s), and reset the status indicator of the RSEG control register. Other SMM options such as, but not limited to flash updates, power-management, chipset errata work-arounds, error logging, etc., also may be performed. Control then passes to block 440, where the system management mode may be exited. Accordingly, control passes back to normal system operation, where an abort completion may be returned to the requester (block 450). For example, the caching logic may generate and forward false data as part of a completion message, e.g., an abort completion message such as a CRAB_abort completion message. While shown with this particular implementation the embodiment of FIG. 4, understand the scope of the present invention is not limited in this regard.

Note that the operations of FIGS. 3 and 4 may be followed even if implemented in other than the caching agent. For example, they could be implemented in a memory controller (MC), if the MC can trap requests, signal SMI, and then abort the trapped request. Other embodiments can be implemented by distributing these responsibilities among various entities of a system.

Accordingly, in various embodiments, BIOS or OS can create a RO section of host memory for read and execute operations. Additionally, the RSEG region may be overriden and resized for reliability-availability-serviceability (RAS) operations like memory capacity add, memory removal, etc.

Embodiments may be implemented in many different system types. Some such systems may be personal computer (PC)-based systems such as desktops, laptops, notebooks, netbooks, or various types of server systems. However, embodiments may be implemented in other systems such as cellular telephones including so-called smart phones, personal digital assistants, mobile Internet devices, or a system based on a system-on-a-chip (SoC), and so forth.

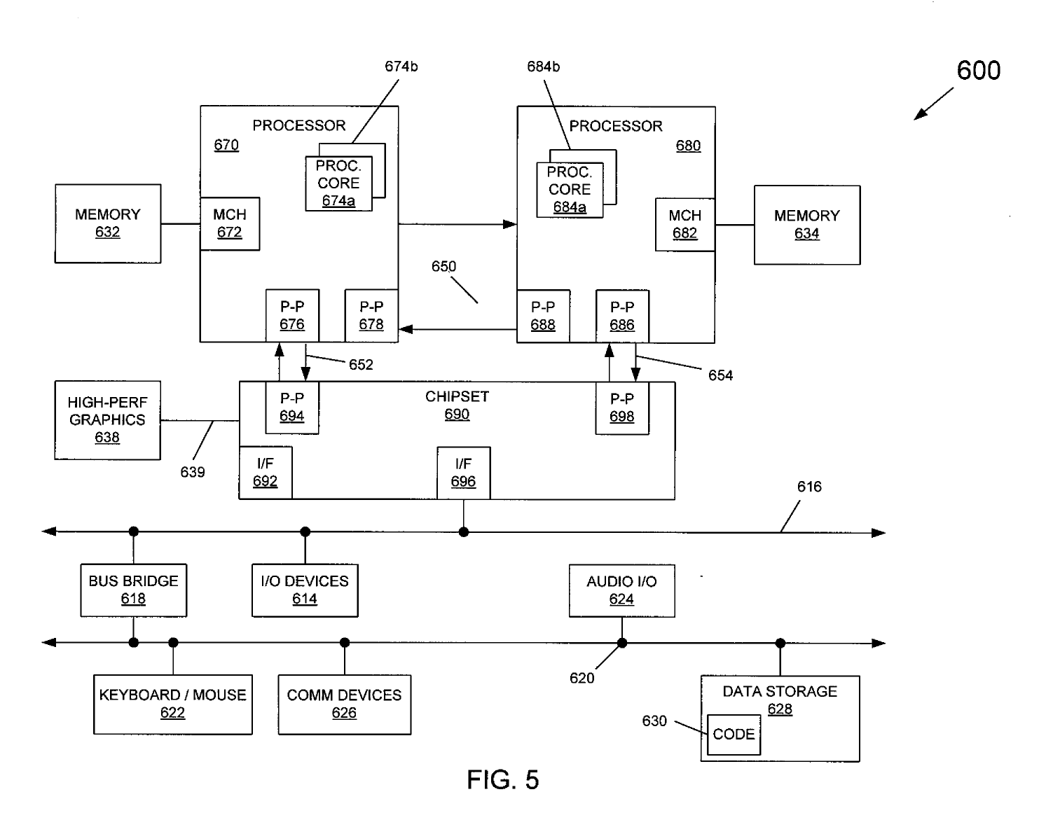

Referring now to FIG. 5, shown is a block diagram of a system in accordance with an embodiment of the present invention. As shown in FIG. 5, multiprocessor system 600 is a point-to-point interconnect system, and includes a first processor 670 and a second processor 680 coupled via a point-to-point interconnect 650. As shown in FIG. 5, each of processors 670 and 680 may be multicore processors, including first and second processor cores (i.e., processor cores 674a and 674b and processor cores 684a and 684b), although potentially many more cores may be present in the processors. These cores may include logic in accordance with an embodiment of the present invention to handle access permissions to a read only region of a system memory.

Still referring to FIG. 5, first processor 670 further includes a memory controller hub (MCH) 672 and point-to-point (P-P) interfaces 676 and 678. Similarly, second processor 680 includes a MCH 682 and P-P interfaces 686 and 688. As shown in FIG. 5, MCH's 672 and 682 couple the processors to respective memories, namely a memory 632 and a memory 634, which may be portions of system memory (e.g., DRAM) locally attached to the respective processors, and which may include one or more read only regions in which various system data can be stored and protected by a combination of the cores, memory controllers, and a chipset 690. First processor 670 and second processor 680 may be coupled to chipset 690 via P-P interconnects 652 and 654, respectively. As shown in FIG. 5, chipset 690 includes P-P interfaces 694 and 698.

Furthermore, chipset 690 includes an interface 692 to couple chipset 690 with a high performance graphics engine 638, by a P-P interconnect 639. In turn, chipset 690 may be coupled to a first bus 616 via an interface 696. As shown in FIG. 5, various input/output (I/O) devices 614 may be coupled to first bus 616, along with a bus bridge 618 which couples first bus 616 to a second bus 620. Various devices may be coupled to second bus 620 including, for example, a keyboard/mouse 622, communication devices 626 and a data storage unit 628 such as a disk drive or other mass storage device which may include code 630, in one embodiment. Further, an audio I/O 624 may be coupled to second bus 620.

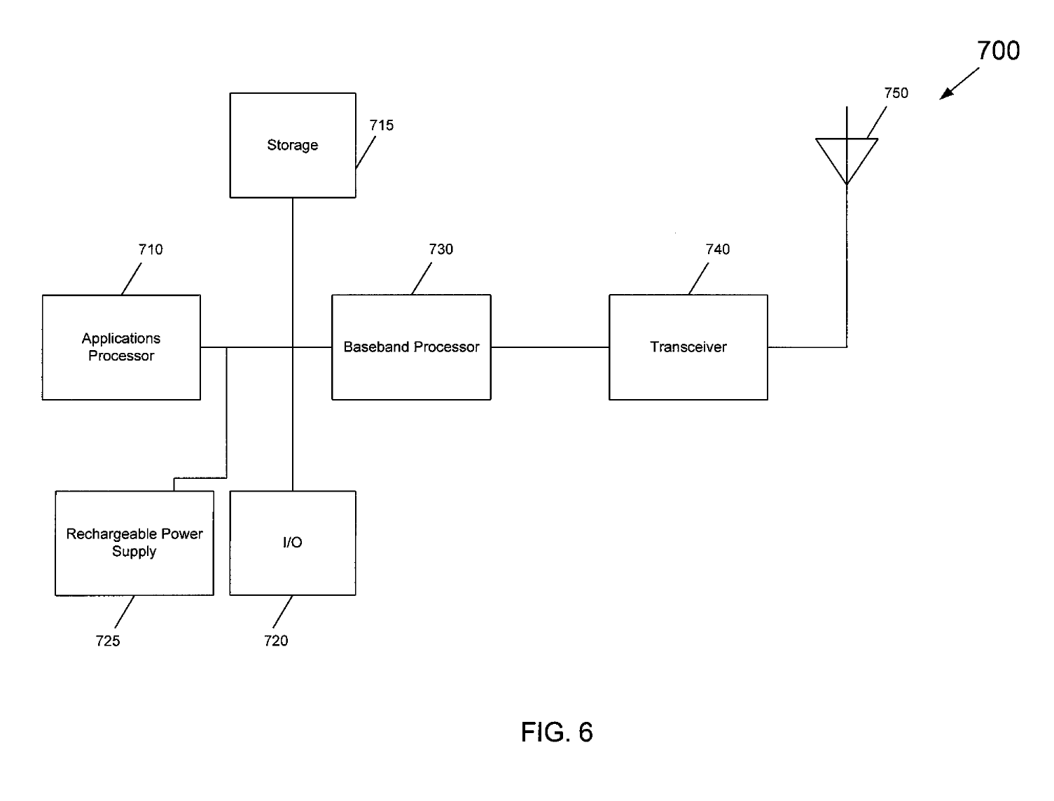

As discussed above, embodiments can be incorporated into other types of systems including mobile devices such as a cellular telephone. Referring now to FIG. 6, shown is a block diagram of a system in accordance with another embodiment of the present invention. As shown in FIG. 6, system 700 may be a mobile device and may include various components. As shown in the high level view of FIG. 6, an applications processor 710, which may be a central processing unit of the device, is in communication with various components including a storage 715. Storage 715, in various embodiments, may include both program and data storage portions and can be mapped to provide for secure storage in accordance with an embodiment of the present invention. Applications processor 710 may further be coupled to an input/output system 720, which in various embodiments may include a display and one or more input devices such as a touch keypad, which itself can appear on the display when executed.

Applications processor 710 also may couple to a baseband processor 730 which conditions signals such as voice and data communications for output, as well as to condition incoming telephone and other signals. As seen, baseband processor 730 couples to a transceiver 740 which may enable both receive and transmit capabilities. In turn, transceiver 740 may be in communication with an antenna 750 that can be any type of antenna capable of transmitting and receiving voice and data signals via one or more communication protocols such as via a wireless wide area network (e.g., a 3G or 4G network) and/or a wireless local area network (such as a BLUETOOTH™ or so-called WI-FI™ network in accordance with an Institute of Electrical and Electronics Engineers 802.11 standard). As seen, system 700 may further include a rechargeable power supply 725 having a rechargeable battery to enable operation in a mobile environment. While shown with this particular implementation in the embodiment of FIG. 6, the scope of the present invention is not limited in this regard.

Embodiments may be implemented in code and may be stored on a storage medium having stored thereon instructions which can be used to program a system to perform the instructions. The storage medium may include, but is not limited to, any type of non-transitory storage medium, such as disk including floppy disks, optical disks, optical disks, solid state drives (SSDs), compact disk read-only memories (CD-ROMs), compact disk rewritables (CD-RWs), and magneto-optical disks, semiconductor devices such as read-only memories (ROMs), random access memories (RAMs) such as dynamic random access memories (DRAMs), static random access memories (SRAMs), erasable programmable read-only memories (EPROMs), flash memories, electrically erasable programmable read-only memories (EEPROMs), magnetic or optical cards, or any other type of media suitable for storing electronic instructions

While the present invention has been described with respect to a limited number of embodiments, those skilled in the art will appreciate numerous modifications and variations therefrom. It is intended that the appended claims cover all such modifications and variations as fall within the true spirit and scope of this present invention.

What is claimed is:

1. A method comprising:
determining whether a system address map of a system includes support for a read only region of system memory;
if so, configuring the read only region and storing protected system data in the read only region, at least a portion of the protected system data readable in both a system management mode (SMM) and a non-SMM and writable only in the SMM; and
accessing the protected system data in the read only region during execution of code in the non-SMM.

2. The method of claim 1, further comprising reconfiguring the read only region during system operation using basic input/output system (BIOS).

3. The method of claim 1, further comprising storing advanced configuration and power interface (ACPI) data as at least a portion of the protected system data in the read only region.

4. The method of claim 1, further comprising receiving a write request to a location in the read only region during execution of non-SMM code from a peripheral device of the system, and responsive to the write request directly sending a completion message including false data from a caching agent to the peripheral device.

5. The method of claim 1, further comprising receiving a write request to a location in the read only region during execution of non-SMM code from a peripheral device of the system and responsive to the write request signaling a system management interrupt.

6. The method of claim 5, further comprising entering the SMM and handling the write request in the SMM.

7. The method of claim 6, further comprising returning an abort completion to the peripheral device, wherein the abort completion includes false data.

8. A system comprising:
a processor to execute instructions;
a chipset coupled to the processor and including a system address map corresponding to an address space of the system, the system address map to associate logical addresses to physical addresses, wherein the system address map includes a mapping of logical addresses to at least one read only region of a system memory, the read only region readable in an untrusted mode and writable only in a trusted mode; and
the system memory coupled to the processor, wherein the system memory comprises a dynamic random access memory (DRAM).

9. The system of claim 8, further comprising a caching agent coupled to the system memory, wherein the caching agent is to store information from the read only region responsive to a read request.

10. The system of claim 9, further comprising a logic coupled to the caching agent to determine whether to allow storage of the information from the read only region into the caching agent.

11. The system of claim 10, wherein the logic is to enable the storage to the caching agent responsive to the read request and to prevent storage of second information from the read only region responsive to a write request initiated in the untrusted mode.

12. The system of claim 10, wherein the logic is to trap a write request to the read only region occurring in the untrusted mode.

13. The system of claim 12, wherein the logic is to generate a system management request to cause a system management mode (SMM) handler to execute responsive to the write request.

14. The system of claim 13, wherein the logic is to return an abort completion to a requester of the write request.

15. The system of claim 8, further comprising a set of registers including a first pair of registers to store information regarding a location of the read only region in the system memory, and a control register to store an enable indicator to identify whether the read only region is configured and a status indicator to indicate that a non-permitted agent attempted to access the read only region.

16. The system of claim 15, wherein the non-permitted agent comprises non-system management mode (SMM) code seeking write access to the read only region.

17. An article comprising a machine-accessible storage medium including instructions that when executed cause a system to:
determine whether a system memory includes a read only region configured by system firmware;
if so, store protected system data written by the system firmware in a trusted mode; and
access the protected system data in the read only region during execution of code in an untrusted mode.

18. The article of claim 17, further comprising instructions to receive a write request to a location in the read only region during execution of the untrusted code from a peripheral device of the system, and responsive to the write request signal an interrupt to enable entry into the trusted mode.

19. The article of claim 18, further comprising instructions to return an abort completion to the peripheral device, wherein the abort completion includes false data.

20. The article of claim 17, further comprising instructions to cache at least a first portion of the protected system data in a shared state in a cache memory of the system in the untrusted mode, and to cache at least a second portion of the protected system data in an exclusive state in the cache memory in the trusted mode.
